(19) United States
(12) Patent Application Publication
(10) Pub. No.: US 2014/0261018 A1
(43) Pub. Date: Sep. 18, 2014

(54) FOOD PROCESSING DEVICE

(71) Applicant: Katz Design Inc., Montreal (CA)

(72) Inventors: Robert Katz, Montreal (CA); Sylvain Duchesne, Bromont (CA)

(73) Assignee: Katz Design Inc., Montreal (CA)

(21) Appl. No.: 14/216,338

(22) Filed: Mar. 17, 2014

Related U.S. Application Data
(60) Provisional application No. 61/786,972, filed on Mar. 15, 2013.

(51) Int. Cl. A47J 43/044

(52) U.S. Cl. CPC A47J 43/044
USPC 99/495

(57) ABSTRACT

A food processing device that manually operates for rotating a drive mechanism where a spring is used to create potential energy when the spring is pulled by a handle and to impart rotation to the drive mechanism when the handle is released.

### CROSS-REFERENCE TO RELATED APPLICATION

This application claims priority from U.S. Provisional Patent Application No. 61/786,972 filed on Mar. 15, 2013 and hereby incorporated by reference herein.

### FIELD OF THE INVENTION

The present invention relates to a food processing device that manually operates for rotating a drive mechanism where a spring is used to create potential energy when the spring is pulled by a handle and to impart rotation to the drive mechanism when the handle is released.

### BACKGROUND OF INVENTION

There have been many devices conceived to aid in the removal of water used to wash food. In the general marketplace, these devices are commonly known as “salad spinners”. They typically have a basket or bowl for receiving the washed food. The basket is rotatable at a relatively high rate to assist with water removal using centrifugal forces. Typically, a drive mechanism is housed in a lid or cover and the drive mechanism engages the basket for rotating it at a high rate. Several means have been developed which use gearing systems, pull cord and electrical drive systems to rotate the basket.

For example, the device may comprise a drive mechanism having an actuator (handle) that is manually operable by a user, a drive shaft and a drive transmission system connected to the actuator and to the drive shaft in order to transmit a driving force applied to the actuator to rotate the drive shaft.

Although manually operated food processing devices with such a drive mechanism provide decent rotating forces, there is a need for a drive mechanism providing more efficient rotating forces with less effort exerted by the user.

### SUMMARY OF THE INVENTION

According to one aspect, the invention provides a food processing device, comprising: a basket for receiving food; a bowl for receiving the basket, wherein the basket is rotatable about the bowl according to a longitudinal axis of the device; a drive lid adapted to be mounted to the basket; a drive transmission mechanism for rotating the drive lid; a ratchet assembly mounted between the drive lid and the drive transmission mechanism; an actuator manually operable by a user between a first operable position and a second operable position; a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator; a cover defining a housing for at least partially receiving the drive transmission mechanism, ratchet assembly, actuator and linking member, the cover being located above the drive lid; and a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the drive lid, and when the user releases the actuator from the second operable position, the spring imparts rotational movement to the linking member and drive transmission mechanism, which in turn imparts rotational movement to the drive lid upon engagement of the ratchet assembly with the drive transmission mechanism.

According to another aspect, the invention provides a food processing device, comprising: a bowl for receiving food; a shaft with at least one blade, the shaft extending along a longitudinal axis of the device; a drive transmission mechanism for rotating the shaft; a ratchet assembly mounted between the shaft and the drive transmission mechanism; an actuator manually operable by a user between a first operable position and a second operable position; a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator; a cover defining a housing for at least partially receiving the drive transmission mechanism, ratchet assembly, actuator and linking member, the cover being located above the bowl; and a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the shaft, and when the user releases the actuator from the second operable position, the spring imparts rotational movement to the linking member and drive transmission mechanism, which in turn imparts rotation movement to the shaft upon engagement of the ratchet assembly with the drive transmission mechanism.

According to a further aspect, the invention provides a food processing device, comprising: a basket for receiving food; a bowl for receiving the basket, wherein the basket is rotatable about the bowl according to a longitudinal axis of the device; a drive lid adapted to be mounted to the basket; a drive transmission mechanism for rotating the drive lid; an actuator manually operable by a user between a first operable position and a second operable position; a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator; a cover defining a housing for at least partially receiving the drive transmission mechanism, actuator and linking member, the cover being located above the drive lid; and a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the drive lid, and when the user releases the actuator from the second operable position, the spring imparts rotational movement to the linking member and drive transmission mechanism, which in turn imparts rotation movement to the drive lid wherein the drive transmission mechanism has a gear ratio between 5/1 and 40/1 such that half a turn of the actuator produces between ten and eighty rotations of the drive lid.

According to another aspect, the invention provides a food processing device, comprising: a bowl for receiving food; a shaft with at least one blade, the shaft extending along a longitudinal axis of the device; a drive transmission mechanism for rotating the shaft; an actuator manually operable by a user between a first operable position and a second operable position; a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator; a cover defining a housing for at least partially receiving the drive transmission mechanism, actuator and linking member, the cover being located above the bowl; and a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the shaft, and when the user releases the actuator from the second operable position, the spring imparts rotational movement to the linking member and drive transmission mechanism, which in turn imparts rotation movement to the shaft wherein the drive transmission mechanism has a gear ratio between 5/1 and 40/1 such that half a turn of the actuator produces between ten and eighty rotations of the shaft.

It is a feature of the invention to provide a food processing device with novel means to rotate elements at high rotational speeds to accomplish tasks such as drying foods using centrifugal forces.

It is further a feature of the invention to provide a food processing device with rotating elements using a power assisted spring to drive the rotating elements without the need for electricity.

It is a further feature of the invention to provide a food processing device with a power assisted drive system to cause the food containment basket to rotate with a power assisted loaded spring.

It is also a feature of the invention to provide a food processing device with a power assisted drive system to cause at least one food processing blade to rotate with a power assisted loaded spring.

It is also a feature of the invention to provide a food processing device with a speed reduction means to decelerate the rotating food basket in a controlled fashion.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 is a perspective view of a food processing device according to a first embodiment of the present invention;

FIG. 2 is a cross-sectional view of the food processing device of FIG. 1;

FIG. 3 is a first exploded view of the cover of the food processing device of FIG. 1;

FIG. 4 is a second exploded view of the cover of the food processing device of FIG. 1;

FIG. 5A is a bottom view of parts of the drive mechanism of the food processing device of FIG. 1;

FIG. 5B is a bottom view of parts of the drive mechanism and cover of the food processing device of FIG. 1;

FIG. 6 is an exploded view of the drive gear, cover and basket of the food processing device of FIG. 1;

FIGS. 7A, 7B and 7C are enlarged views of parts of the brake actuator of the food processing device of FIG. 1;

FIG. 8 is a perspective view of a food processing device according to a second embodiment of the present invention;

FIG. 9 is a perspective view of the food processing device of FIG. 8 with the handle shown in a first operable position;

FIG. 10 is a perspective view of the food processing device of FIG. 8 with the handle shown in a second operable position;

FIG. 11 is an exploded view of the food processing device of FIG. 8;

FIG. 12 is a bottom perspective view of an example of the drive transmission mechanism of the food processing device of FIG. 8;

FIG. 13 is a top view of parts of the drive transmission mechanism and cover of the food processing device of FIG. 8 with the upper lid not being shown and with the handle and spring shown in a first position;

FIG. 14 is a top view of parts of the drive transmission mechanism and cover of the food processing device of FIG. 8 with the upper lid not being shown and with the handle and spring shown in a second position; and

FIG. 15 is a bottom perspective view of the upper lid.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

To facilitate the description, any reference numeral designating an element in one figure will designate the same element if used in any other figures. In describing the embodiments, specific terminology is resorted to for the sake of clarity but the invention is not intended to be limited to the specific terms so selected, and it is understood that each specific term comprises all equivalents.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure. Similarly, the terms “inwardly,” “outwardly” and “radially” generally refer to the orientation of a surface relative to its axis of elongation, or axis of rotation, as appropriate.

Referring to FIGS. 1 to 6, the food processing device 10 has a cover 12 and a bowl 14. The cover 12 has an upper lid 13, a lower lid 20 and a middle plate 26 located between the upper and lower lids 13, 20, as well as a manually power assisted drive mechanism comprising a handle 17 that is manually operable by a user in order to actuate a spring 84.

The device 10 further comprises a perforated basket 16 adapted to receive food (salad or vegetables) and that can be used to rinse the food after washing. The basket 16 is located within the bowl 14, the bowl 14 having a pivot projection 62 extending upwardly from the base of the bowl 14 at the center of the bowl 14 and the basket 16 has a pivot depression 60 registering with the pivot projection 62 for allowing the basket 16 to rotate freely on the pivot projection 62.

The lower lid 20 is affixed to the upper lid 13 by way of mechanical fasteners, ultrasonic welding, adhesives or other like means. The upper lid 13 also comprises screw bosses 44 to permit the assembly of the upper lid 13 to the lower lid 20. The upper lid 13 may also comprise abutment means 54 and a peripheral lip 64 and the lower lid 20 may comprise receiving steps and a peripheral lip 66 for registering with the respective abutment means 54 and peripheral lip 64 of the upper lid 13.

The device 10 further comprises a drive lid 24 nested into the top circumference of the basket 16, and held to and driven by a center drive gear 22 which is actuated by the manually power assisted drive mechanism.

The upper lid 13 has a pivot member 48 having a spaced split 52 to permit circumferential compression of a retaining lip 50 used to hold the middle plate 26 by way of a cylindrical protrusion 70 provided on the middle plate 26 such that the protrusion 70 is snapped onto the pivot member 48 for affixing the upper lid 13 and middle plate 26 together. The middle plate 26 is thus freely rotatable about the pivot member 48.

The handle 17 has a handle pivot 30 mounted into a cavity 68 provided on the middle plate 26. The handle pivot 30 has an inverse “T” shape whereby the cross member of the “T” is allowed to pivot freely within the cavity 68 and a slot 72 provided on the middle plate 26 permits the upright portion of the “T” shaped pivot 30 to rotate 90° permitting the upright member to point upwards or outwards. The handle 17 also has handle halves 28a, 28b that are assembled generally at their center and can be joined by way of mechanical assembly, adhesive assembly or other like means onto the handle pivot 30. The handle pivot 30 may have a groove 76 registering with the lower shells of handle halves 28a, 28b.

The upper lid 13 may have a cavity 80 molded into the lid 13 to accommodate the handle 17 (see FIGS. 1 and 4) if rotated downward when the device 10 is not in use.

It should be noted that the upright member of the “T” shaped handle pivot 30 registers within a groove 78 provided in the upper lid 13 such that the handle 17 and its pivot 30 may be displaced along the peripheral walls defining the groove 78, the length of such displacement and the corresponding displacement of the middle plate 26 being thus limited by the length of the groove 78 that has first and second abutments 114a, 114b at its respective ends (see FIG. 4).

As best seen in FIG. 3, the underside of the middle plate 26 defines a cavity 82 for receiving the spring 84, which has first and second looped ends 86a, 86b at the respective ends of the extension spring 84.

The first end 86a of the spring 84 is affixed to the middle plate 26 at a cavity 74 provided in the middle plate 26 and a retention pin 40 is inserted into the cavity 74 and into the first end 86a for affixing this first end 86a to the middle plate 26.

The second end 86b of the spring 84 is affixed to the lower lid 20 via a retention pin 42 received in a housing 90 provided on the top side of the lower lid cover 20.

As best seen in FIG. 3, the underside of the middle plate 26 also defines a geared ring 58 concentrically located around the longitudinal axis of the device 10. The underside of the middle plate 26 further defines a peripheral wall 88 for guiding the spring 84 as the handle 17 displaces (pulls) the spring 84 for loading the spring 84 and creating potential energy.

The geared ring 58 engages with a central gear 96 provided on a ratchet gear 34 having ratchet teeth 94. As the user displaces the handle 17 along the peripheral groove 78, this movement rotates the middle plate 26 and its geared ring 58 in a counterclockwise direction, and then turns the center gear 96 without rotating the drive gear 36 (and thus without rotating the basket 16) since the teeth 94 of the ratchet gear 34 are not engaged by ratchet stops (pawls) 32a, 32b. Displacement of the handle 17 thus pulls the spring 84 for loading potential energy into the drive mechanism without using energy for turning the drive gear 36.

As best seen in FIG. 4, a crank gear 36 is mounted on a pivot member 92 extending upwardly from the lower lid 92. Mounting can be achieved in numerous ways including but not limited to the crank gear 36 snapping onto the pivot member 92.

Mounted concentrically onto the same pivot member 92 is the ratchet gear 34 having ratchet teeth 94 provided on its perimeter. The device 10 also comprises the ratchet stops (pawls) 32a, 32b that are held by pivots members 100a, 100b mounted within the crank gear 36 (see FIG. 5A). Because of the shape and orientation of the ratchet stops 32a, 32b, the ratchet stops 32a, 32b do not engage with the ratchet teeth 94 when the ratchet gear 34 rotates in a counterclockwise direction when the handle 17 is displaced by the user.

However, when the handle 17 is released by the user and the spring 84 imparts rotation to the drive mechanism, the ratchet stops 32a, 32b are adapted to engage with the ratchet teeth 94 when the ratchet gear 34 rotates in a clockwise direction such that the crank gear 36 then turns. Slight pressure of the ratchet stops 32a, 32b onto the teeth 94 of the ratchet gear 34 is created by springs 98a, 98b that are also mounted within the crank gear 36 (see FIG. 5A). The springs 98a, 98b may be conventional compression springs, integral springs or other like springs.

Once the handle 17 is released by the user, the spring 84 imparts rotation to the middle plate 26 and its geared ring 58 in a clockwise direction, which in turn rotates the gear 96 and ratchet gear 34 in a clockwise direction. As the ratchet stops 32a, 32b engage the ratchet gear 34, the drive gear 36 is entrained in the same direction as well. The drive gear 36 is associated by way of interlocking gear teeth with the center drive gear 22 and the clockwise rotation of the drive gear 36 turns the center drive gear 22 in a counterclockwise direction. The center drive gear 22 is held by a screw 102 and is able to turn freely within a hole 103 provided on the lower lid cover 20 (see FIG. 3).

Referring to FIGS. 4 and 6, the center drive gear 22 has a shaft 104 for connecting the drive mechanism to the drive lid 24. The drive lid 24 has a hole 108 into which the shaft 104 is snapped. Other means to affix the center drive lid 24 to the drive gear 22 can be conceived of by someone skilled in the art. The shaft 104 may have a key groove 106 for mating with at least one anti-rotational key element 110 provided in the hole 108 of the drive lid 24. The drive lid 24 nests into the upper perimeter of the basket 16 and further engages it by way of multiple registration teeth 112 which nest in between the ribs 113 of the basket 16. As the center drive gear 22 rotates, it also rotates the drive lid 24 by way of this engagement.

By cranking the handle 17, the spring 84 is pulled in order to load potential energy into the drive mechanism, and then by releasing the handle 17, the spring 84 drives the middle plate 26 and its geared ring 58 in a clockwise direction, which then turns the center gear 96 and ratchet gear 34, which then turns the drive gear 36 because of the engagement of the ratchet stops 32a, 32b with the teeth 94 of the ratchet gear 34, and the drive gear 36 finally imparts rotation of center drive gear 22, drive lid 24 and basket 16 according to a gear ratio wherein half a turn of the handle 17 will generate ten, twenty or forty rotations of the center drive gear 22. The gear ratios thus permit a single movement of the handle 17 to rotate the basket 16 at a higher rate of revolutions. For example, the gear ratio of the drive mechanism may be 20/1 such that half a turn of the handle produces forty rotations of the basket 16 or the gear ratio may be 40/1 such that half a turn of the handle produces eighty rotations of the basket 16.

It is understood that the drive mechanism may be connected to a basket adapted to receive food (salad or vegetables) in order to impart rotation to the basket and spin water from the food. The drive mechanism may alternatively be connected to a shaft having at least one blade, cutters or knife for cutting or chopping food residing in a bowl in which the shaft is mounted. In that sense, the same mechanism can be used for other food processing operations requiring processing elements to rotate at high speeds while the generation of force to perform these tasks is power assisted by the mechanism.

The device 10 may also comprise a speed reduction feature. After loading the spring 84 by way of rotationally displacing the handle 17 in a counterclockwise direction, and then releasing it, the internal gear systems all engage and transfer power from the spring 84 to rotate the associated gears and ultimately turn the basket 16 containing wet food items. Once the handle reaches the first abutment 114a, the middle plate 26 and its geared ring 58 terminate their rotating action on the center gear 96 and the spring 84 no longer exerts force for rotating the gear system. At that point, the ratchet stops 32a, 32b no longer engage with the teeth 94 of the ratchet gear 34 such that the drive gear 36, center drive gear 22, drive lid 24 and basket 16 continue to turn by way of the energy accumulated in these components (under the action of inertia). This rotation may require to be controlled by the user whereby the user may wish to slow the rotation of the basket 16 to cause it to eventually come to a stop.

Referring to FIG. 4 and FIGS. 7A, 7B, 7C, the device 10 may also comprise a brake actuator 18 mounted into a recess 120 provided on the upper lid 13 at its top center point. The upper lid 13 has a flange 113 provided in the base of the recess 120 with an opening 115. The actuator has a snapping member 117 to be inserted in the opening 115 for preventing the brake actuator 18 from being removed from the recess 120. The brake actuator 18 has upper and lower surfaces 126, 121 and two legs 122a, 122b, each leg having a spring element 118 that may pivot inwardly at a sprung hinge 119, a snap 117 and a lower edge 116. In the vertical axis, the brake actuator 18 is permitted to move with some limited travel with the base of the upper surface 121 abutting the flange 113 in the lowest position. The spring element 118 causes the brake actuator 18 to be forced upward such that the top surface 126 is even with the top surface of the upper lid 13. The sloped surface of the spring 118 contacts the flange 113 and is flexed inward at the hinge 119. When the brake actuator 18 is released, the spring 118 pushes outward and forces the brake actuator 18 upward until the snap 117 abuts the lower side of the flange 113. As seen in FIGS. 3 and 4, the device 10 also comprises a friction interface 38 mounted to the top surface of the center gear 22. When the brake actuator 18 is pushed down, the lower edge 116 of each leg presses on the friction interface 38 and slows the rotation of the center gear 22 and drive lid 24 and subsequently the basket 16 to which it is attached.

FIGS. 8 to 11 show a food processing device according to a second embodiment and designated by the reference numeral 200. The device 200 comprises a bowl 210 for receiving food such as vegetables or fruit, a drive lid 220, a ratchet assembly 230 mounted between the drive lid 220 and a drive transmission mechanism 240 and a linking member 250 mounted between the drive transmission mechanism 240 and a manually operable actuator 260. The linking member 250 and actuator 260 are both connected to a spring 270 and the device 200 also comprises a cover 280 defining a housing 281 for receiving the transmission mechanism 240, linking member 250, actuator 260 and spring 270.

While the drive transmission mechanism 240 may be connected to the drive lid 220 for rotating a basket 290 received in the bowl 210, drive transmission mechanism 240 is connected indirectly to drive lid 220 by way of a ratchet system 230. The basket 290 having an upper rim 291 with an internal peripheral wall 292 and a plurality of longitudinal projections 293, the basket further comprising a plurality of apertures 294 and being adapted to receive food being washed (salad or vegetables), the drive mechanism 240 may rather be connected to a shaft having at least one blade, cutter or knife (not shown) for cutting food received in a basket in which the shaft is mounted.

The actuator 260 may comprise an upper lid 261 with upper and lower surfaces 262, 263 and a peripheral wall 264, the upper lid 261 having a pin (not shown) extending from the lower surface 263 and a cavity 266 provided on the peripheral wall 264 of the upper lid 261.

The actuator 260 may also comprise a handle 267 pivotably mounted to the upper lid 261. The handle 267 may have handle halves 267a, 267b that are assembled generally at their center and a T-shaped member 267c whereby the cross member of the “T” is allowed to pivot freely within the cavity 266 such that the handle 267 can be in a retracted position, wherein the handle 267 is received in a recess 282 provided in the cover 280 when the device is not used (see FIG. 8), and a first operable position wherein the handle 267 projects from the cover 280 such that the user can actuate (turn or displace) the handle 267 from the first operable position (see FIG. 9) to a second operable position (see FIG. 10).

Referring to FIG. 15, the T-shaped member 267c is lodged in a cavity of the upper lid 261. Ribs may protrude from the lower surface 263 so as to create a semi-circular shape which matches the outside shape of the T-shaped member 267c and permits it to rotate freely about its horizontal axis while being held in the cavity. Abutment walls may assist in holding the T-shaped member 267c in place. Screw bosses hold a cover plate which in turn holds the T-shaped member 267c in place. The pin 265 protrudes from the lower surface 263 of the upper lid 260.

Referring to FIGS. 11 and 14, the upper lid 261 is held by a screw (not shown) screwed into the center aperture 269 and is held in a screw boss in the top centre surface of the drive transmission mechanism 240. A washer under the screw permits free rotation of the upper lid 261 without binding the upper lid 261 to the cover 280. The upper lid 261 is also held by a peripheral lip 264A found on the perimeter wall 264 which snaps into a plurality of overhanging snap receiver lips 287 spaced at equal intervals in the housing 281 of the cover 280. The upper lid 261 is able to rotate freely within the housing 281 of the cover 280 once the lip 264A is snapped below the lips 287.

As best seen in FIGS. 11 and 12, the drive transmission mechanism 240 may comprise a planetary gearing system having a casing 241 mounted within the housing 281 of the cover 280, the gearing system comprising an outer ring 242 that is fixed and that is in meshing engagement with first, second and third upper planet gears 243ua, 243ub, 243uc and first, second and third lower planet gears 2431a, 2431b, 2431c, the first, second and third planet lower gears 2431a, 2431b, 2431c meshing with a sun gear 244.

Mounted onto the sun gear 244 is a drive member 245 with a distal end defining an aperture 246. It is understood that the sun gear 244 and drive member 245 can be integral parts of a single component.

The gearing system may also comprise upper and lower plates 247u, 2471 with axis members for transmitting rotating movement to the first, second and third upper planet gears 243ua, 243ub, 243uc and first, second and third lower planet gears 2431a, 2431b, 2431c respectively. The upper plate 247u may also define a peripheral wall with a plurality of sides for defining a hexagonal peripheral wall 248.

The linking member 250 has at one end an aperture 251 defined by a plurality of sides such that the hexagonal peripheral wall 248 of the upper plate 247u registers within the aperture 251 of the linking member 250. At the other end, the linking member 250 has a ring 252 with a hole 253, a pin 254 and a shoulder 255 with a hole 256, the ring 252 extending upwardly and the pin 254 extending downwardly. The pin 265 of the upper lid 260 is thus adapted to register within the hole 253 of the ring 252 such that the rotating movement of the upper lid 260 is transmitted to the linking member 250, which in turn transmits the rotating movement to the drive transmission mechanism 240 via the upper plate 247u. As indicated previously, rotating movement of the upper lid 260 is imparted when the user turns the handle 267 from the first operable position shown in FIG. 9 to the second operable position shown in FIG. 10.

The drive lid 220 has a ring 221 with ratchet teeth 222 and a center projection 223 adapted to register within the aperture 246 of the drive member 245 and the drive lid 220 is mounted to the drive member 245 by a screw 224 such that the drive lid 220 is freely rotatably connected to the drive member 245.

The drive lid 220 may also have an exterior peripheral wall 225 with a plurality of projections or recess 226, the peripheral wall 225 being adapted to be inserted within the internal peripheral wall 292 of the basket 290 and the projections or recess 226 of the drive lid 220 being adapted to engage the projections 293 of the basket 290 such that rotation of the drive lid 220 is transferred to the basket 290.

Referring to FIGS. 13 and 14, which show components without the upper lid 260 in order to better illustrate the housing 281 of the cover 280, the bottom wall of the housing 281 of the cover 280 has a peripheral groove 283 extending along an angle of about 180° from a first abutting end 284 to a second abutting end 285. The pin 254 of the linking member 250 thus registers within the peripheral groove 283 of the cover 280 for guiding rotational movement of the linking member 250 relative to the cover 280. The spring 270 has first and second ends 272, 273, the first end 272 being mounted in the hole 256 of the shoulder 255 of the linking member 250 and the second end 273 being mounted in a hole or to a member 286 provided in the housing 281 of the cover 280.

As seen in FIG. 13, when the handle 267 is in the first operable position, the spring 270 is in a first mode wherein little tension is created by the spring 270. However, when the user turns the handle 267 up to the second operable position shown in FIG. 14, the spring 270 is pulled for loading potential energy into the drive transmission mechanism 240 without using energy for turning the drive lid 220. To this effect, the device 200 also comprises the ratchet assembly 230 wherein no rotating movement is imparted to the drive lid 220 when the handle 267 is turned counterclockwise up to the second abutting end 285, and when the handle 267 is released by the user, rotating movement is imparted to the drive lid 220 upon rotation in the clockwise direction of the handle 267, linking member 250 and drive transmission mechanism 240 under the pulling action of the spring 270.

The ratchet assembly 230 has a center member 231 with a hole defined by a plurality of side walls wherein the hole is an hexagonal hole 232 adapted to receive the distal end of the drive member 245. The distal end of the drive member 245 may have a hexagonal peripheral wall such that the distal end registers within the hexagonal hole 232 of the center member 231. The center member 231 also has first and second pins for receiving respective proximal ends of first and second pawls 233, 234 such that the first and second pawls 233, 234 are hinged for free pivotal movement about the first and second pins of the center member 231.

The lid cap 268, center aperture 269 of the upper lid 261, aperture 251 of the linking member 250, upper plate 247u, sun gear 244 and drive member 245 of the gearing system, center member 231 of the ratchet assembly 230, and ring 221 and center projection 223 of the drive lid 220 are mounted concentrically relative to the longitudinal axis A-A of the device 200 and the first and second pawls 233, 234 are arranged symmetrically about the axis A-A for free rotation relative to the center member 231.

Because of the shape and orientation of the first and second pawls 233, 234, the first and second pawls 233, 234 do not engage with the ratchet teeth 222 of the drive lid 220 when the drive transmission mechanism 240, linking member 250 and actuator 260 are rotated in a counterclockwise direction when the handle 267 is displaced by the user such that no rotational movement is imparted to the drive lid 220.

However, when the handle 267 is released by the user and the spring 270 imparts rotation to the linking member 250 and drive transmission mechanism 240, the first and second pawls 233, 234 are adapted to engage with the ratchet teeth 222 of the drive lid 220 when the drive member 245 of the mechanism 240 rotates in a clockwise direction such that the drive lid 220 then turns in a clockwise direction and the basket 290 also turns in the same direction according to a gear ratio wherein half a turn of the handle 267 will generate ten, twenty or forty rotations of the drive member 245.

The gear ratios thus permit a single movement of the handle 267 to rotate the drive lid 220 at a higher rate of revolutions.

For example, the gear ratio of the drive transmission mechanism 240 may be 5/1 such that half a turn of the handle 267 produces ten rotations of the drive member 245, or may be 10/1 such that half a turn of the handle 267 produces twenty rotations of the drive member 245, or may be 20/1 such that half a turn of the handle 267 produces forty rotations of the drive member 245 or may be 40/1 such that half a turn of the handle 267 produces eighty rotations of the drive member 245.

Once the handle reaches the first abutting end 284, the spring 270 retains some tensile loading on the linking member 250 but due to the abutting end 284 the linking member 250 terminates its rotating action on the drive transmission mechanism 240. At that point, the drive transmission mechanism 240 and center member 231 cease to rotate and the first and second pawls 234, 235 no longer engage with the ratchet 222 of the drive lid 220 such that the drive transmission mechanism 240, drive lid 220 and basket 290 continue to turn by way of the energy accumulated in these components (under the action of inertia).

The device 200 may comprise a brake mechanism 300 for allowing the user to slow the rotation of the basket 290 and/or to eventually stop this rotation. The brake mechanism 300 may comprise an actuator 301 mounted to the cover 280, the actuator 301 having a shaft 302 with an abutting end 303 adapted to contact the upper surface of the drive lid 220 and a spring 304 mounted on the shaft 302, the spring 304 biasing the actuator 301 towards a position wherein the abutting end 303 does not contact the upper surface of the drive lid 220.

Upon pressing on the actuator 301 by the user, pressure exerted on the actuator 301 then compresses the spring 304 such that the abutting end 303 contacts the upper surface of the drive lid 220 for slowing the rotation of the drive lid 220 and basket 290.

Any feature of any embodiment discussed herein may be combined with any feature of any other embodiment discussed herein in some examples of implementation.

Various embodiments and examples have been presented for the purpose of describing, but not limiting, the invention. Various modifications and enhancements will become apparent to those of ordinary skill in the art and are within the scope of the invention, which is defined by the appended claims.

1. A food processing device, comprising:
a basket for receiving food;
a bowl for receiving the basket, wherein the basket is rotatable about the bowl according to a longitudinal axis of the device;
a drive lid adapted to be mounted to the basket;
a drive transmission mechanism for rotating the drive lid;
a ratchet assembly mounted between the drive lid and the drive transmission mechanism;
an actuator manually operable by a user between a first operable position and a second operable position;
a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator;
a cover defining a housing for at least partially receiving the drive transmission mechanism, ratchet assembly, actuator and linking member, the cover being located above the drive lid; and
a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the drive lid, and when the user releases the actuator from the second operable position, the spring imparts rotational movement to the linking member and drive transmission mechanism, which in turn imparts rotational movement to the drive lid upon engagement of the ratchet assembly with the drive transmission mechanism.

2. The food processing device of claim 1, wherein the drive transmission mechanism has a gear ratio of 20/1 such that half a turn of the actuator produces forty rotations of the drive lid.

3. The food processing device of claim 1, wherein the drive transmission mechanism has a gear ratio of 40/1 such that half a turn of the actuator produces eighty rotations of the drive lid.

4. The food processing device of claim 1, wherein the actuator comprises an upper lid that is freely rotatably mounted within the housing of the cover and a handle mounted to the upper lid for rotating the upper lid when the user displaces the handle from the first operable position and the second operable position.

5. A food processing device, comprising:
a bowl for receiving food;
a shaft with at least one blade, the shaft extending along a longitudinal axis of the device;
a drive transmission mechanism for rotating the shaft;
a ratchet assembly mounted between the shaft and the drive transmission mechanism;
an actuator manually operable by a user between a first operable position and a second operable position;
a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator;
a cover defining a housing for at least partially receiving the drive transmission mechanism, ratchet assembly, actuator and linking member, the cover being located above the bowl; and
a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the shaft, and when the user releases the actuator from the second operable position, the spring imparts rotational movement to the linking member and drive transmission mechanism, which in turn imparts rotation movement to the shaft upon engagement of the ratchet assembly with the drive transmission mechanism.

6. The food processing device of claim 5, wherein the drive transmission mechanism has a gear ratio of 20/1 such that half a turn of the actuator produces forty rotations of the shaft.

7. The food processing device of claim 5, wherein the drive transmission mechanism has a gear ratio of 40/1 such that half a turn of the actuator produces eighty rotations of the shaft.

8. The food processing device of claim 5, wherein the actuator comprises an upper lid that is freely rotatably mounted within the housing of the cover and a handle mounted to the upper lid for rotating the upper lid when the user displaces the handle from the first operable position and the second operable position.

9. A food processing device, comprising:
a basket for receiving food;
a bowl for receiving the basket, wherein the basket is rotatable about the bowl according to a longitudinal axis of the device;
a drive lid adapted to be mounted to the basket;
a drive transmission mechanism for rotating the drive lid;
an actuator manually operable by a user between a first operable position and a second operable position;
a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator;
a cover defining a housing for at least partially receiving the drive transmission mechanism, actuator and linking member, the cover being located above the drive lid; and
a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the drive lid, and when the user releases the actuator from the second operable position, the spring imparts rotational movement to the linking member and drive transmission mechanism, which in turn imparts rotation movement to the drive lid wherein the drive transmission mechanism has a gear ratio between 5/1 and 40/1 such that half a turn of the actuator produces between ten and eighty rotations of the drive lid.

10. The food processing device of claim 9, wherein the device further comprises a ratchet assembly mounted between the drive lid and the drive transmission mechanism.

11. The food processing device of claim 10, wherein the ratchet assembly is in driving engagement with the drive transmission mechanism for transmission of rotational movement only in a single direction upon movement of the actuator from the second operable position to the first operable position, movement of the actuator being imparted by the spring.

12. The food processing device of claim 11, wherein the ratchet assembly comprises a ring with ratchet teeth provided on the drive lid.

13. The food processing device of claim 12, wherein the ratchet assembly comprises a center member with a hole around the longitudinal axis of the device and first and second pawls mounted to the center member and arranged symmetrically about the longitudinal axis of the device.

14. The food processing device of claim 13, wherein the first and second pawls are hinged for free pivotal movement.

15. The food processing device of claim 1 or 9, further comprising a braking mechanism for braking rotation of the drive lid, the braking mechanism comprising a manual actuator with a portion accessible by the user, a shaft connected with the manual actuator and having a distal end adapted to contact the drive lid, the shaft being movable between a first position, wherein the distal end does not contact the drive lid, and upon pressure by the user on the portion of the actuator, to a second position, wherein the distal end contacts the drive lid.

16. The food processing device of claim 15, wherein the braking mechanism further comprises a spring for biasing the shaft towards the first position.

17. A food processing device, comprising:
a bowl for receiving food;
a shaft with at least one blade, the shaft extending along a longitudinal axis of the device;
a drive transmission mechanism for rotating the shaft;
an actuator manually operable by a user between a first operable position and a second operable position;
a linking member mounted between the actuator and the drive transmission mechanism, the linking member being rotatable about the longitudinal axis of the device, the linking member comprising a first end with an aperture around the longitudinal axis of the device and an arm with a second end that is movable along an arc of circle relative to the longitudinal axis of the device, the second end being connected to the actuator for imparting rotational movement to the drive transmission mechanism when the user turns the actuator;
a cover defining a housing for at least partially receiving the drive transmission mechanism, actuator and linking member, the cover being located above the bowl; and
a spring with first and second ends, the first end of the spring being affixed to the second end of the linking member and the second end of the spring being affixed to the cover, wherein in use, when the user turns the actuator from the first operable position to the second operable position, the spring is pulled for loading potential energy in the spring while no rotational movement is transmitted to the shaft, and when the user releases the actuator from the second operable position, the spring imparts rotational movement to the linking member and drive transmission mechanism, which in turn imparts rotation movement to the shaft wherein the drive transmission mechanism has a gear ratio between 5/1 and 40/1 such that half a turn of the actuator produces between ten and eighty rotations of the shaft.

18. The food processing device of claim 17, wherein the device further comprises a ratchet assembly mounted between the shaft and the drive transmission mechanism.

19. The food processing device of claim 18, wherein the ratchet assembly is in driving engagement with the drive transmission mechanism for transmission of rotational movement only in a single direction upon movement of the actuator from the second operable position to the first operable position, movement of the actuator being imparted by the spring.

20. The food processing device of claim 19, wherein the ratchet assembly comprises a ring with ratchet teeth mounted to an upper end of the shaft.

21. The food processing device of claim 20, wherein the ratchet assembly comprises a center member with a hole around the longitudinal axis of the device and first and second pawls mounted to the center member and arranged symmetrically about the longitudinal axis of the device.

22. The food processing device of claim 21, wherein the first and second pawls are hinged for free pivotal movement.
